(19) United States
(12) Patent Application Publication
(10) Pub. No.: US 2009/0249067 A1
(43) Pub. Date: Oct. 1, 2009

(54) System and Method for Pre-Placing Secure Content on an End User Storage Device

(75) Inventors: Milton Lie, Plano, TX (US); Brian Forbes, Plano, TX (US); Robert Burke, Dallas, TX (US); Ernest Oakes, Plano, TX (US)

Correspondence Address: FULBRIGHT & JAWORSKI L.L.P, 2200 ROSS AVENUE, SUITE 2800, DALLAS, TX, 75201-2784, US

(73) Assignee: Contineo Systems, Plano, TX (US)

(21) Appl. No.: 12/055,135

(22) Filed: Mar. 25, 2008

(51) Int. Cl. G06F 12/14; H04L 9/14; G06F 17/00

(52) U.S. Cl. 713/167; 726/12

(57) ABSTRACT

A system and method for pre-placing content from a provider on an end user storage device is described. The system includes a device connected to an end user network and a public network and used to interface with one or more digital keys, where each digital key is able to control one or more identity associations. A storage device attached to the end user network and is able to receive content from the provider using the identity association with the provider. The content is encrypted on the storage device using a keys established by the provider, such that the end user can only decrypt and access the content by agreeing to terms established by the provider using the digital key and identity association with the provider.

### TECHNICAL FIELD

The present invention relates to security associations in broadband data networks, and more specifically to systems and methods for allowing service and content providers to pre-place encrypted content on storage devices in an end user's network where the service and content provider can control access to the encrypted content.

### BACKGROUND OF THE INVENTION

A typical system 100 for providing broadband network access to a home network 109 is shown with regard to FIG. 1. In such a broadband network, a home 101 is usually connected to the broadband network 102 by means of a portal 103, such as a cable modem, fiber optic connection such as gigabit passive optical network (GPON), or a digital subscriber line (DSL) modem. The high speed modem typically has a single internet protocol (IP) address associated with it. The IP address may be fixed or may be dynamically allocated by the internet service provider (ISP). In addition to wireline portals, such as the cable or DSL modems, wireless or cellular portals such as WiMax, or femto or pico cell devices may be used to provide the connectivity between the home 101 and the broadband network 102.

Though there is a single IP address associated with the portal 103, there are often multiple devices connecting to broadband network 102 through portal 103. In such a home network, private addressing schemes are used with network address translation (NAT) provided by the portal or a router connected to the portal. In such a private addressing scheme the portal or router assigns a private address to each device connected to the network and then provides the translation between the private address used on the private side of the portal and the public address used to communicate with broadband network 102. The private addresses are usually dynamically assigned by the portal or router as devices are added and removed from the home network.

The topology of home networks, such as the one shown in FIG. 1, make it difficult to establish trusted connections with the end user devices, such as computer 104 or 105, or wireless devices 106, 107 or 108, due to the private addressing scheme used in the home network. The use of identity associations (a secure explicit path through an untrusted network with an established identity for billing purposes) for devices in the end user network would allow carriers and providers to establish a trusted link into the home network. Without identity associations, the service and content providers who wish to deliver service or content to the end user in real time resort to caching such content within their network or a carrier's network. Such caching incurs facility expenses, transport expenses, and consumes valuable network resources. In addition, caching content in the carrier's network can make the consumer's experience vulnerable to network congestion.

What is needed is a system and method that are able to use identity associations between users, carriers, and providers to cache encrypted content on end users' storage devices in such a way that the user has the advantages of locality while the content provider retains access control and content security.

### BRIEF SUMMARY OF THE INVENTION

In certain embodiments, the present invention is directed to a system and method for pre-placing content from a provider on an end user storage device, where the system includes a device connected to an end user network and a public network and used to interface with one or more digital keys, each digital key able to control one or more identity associations, and a storage device attached to the end user network, the storage device operable to receive content from the provider using the identity association with the provider. The content is encrypted on the storage device using keys established by the provider, such that the end user can only decrypt and access the content by agreeing to terms established by the provider using the digital key and identity association with the provider.

In another embodiment, a method for pre-placing content from a provider on an end user storage device is described, where the method includes establishing an identity association between a provider and an end user storage device using a device connected to the end user network and used to interface with one or more digital keys, each digital key able to control one or more identity associations. The method further includes sending content from the provider to the end user storage device over a secure connection using the identity association, encrypting the content on the end user storage device using keys provided by the provider, and decrypting the content in response to a request by the end user, the end user agreeing to terms established by the provider using the digital key and identity association with the provider.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram illustrating an existing home network topology;

FIG. 2 is a block diagram illustrating an embodiment of a system for providing secure, trusted communication between devices in a private network and a core network of a service provider according to the concepts described herein;

FIG. 3 is a block diagram illustrating an alternate embodiment of a system for providing secure, trusted communication between devices in a private network and a core network where the system has separate signaling and media channels;

FIG. 4 is a block diagram illustrating an embodiment of a process used to create a secure identity associate and billing records between a service provider and end user;

FIG. 5 is a block diagram illustrating a embodiment of a process for terminating media streams separately from the associated control stream;

FIG. 6 is a block diagram illustrating an embodiment of a system for pre-placing secured content in an end user's network according to the concepts described herein;

FIG. 7 is a flow chart illustrating an embodiment of a method for pre-placing secured content in an end user's network according to the concepts described herein;

FIG. 8 is a block diagram illustrating an embodiment of a system for pre-placing secured content in an end user's network using multi-cast technology according to the concepts described herein;

FIG. 9 is a diagram illustrating an embodiment of a system for distributing keys within a private network environment for secured content according to the concepts described herein.

### DETAILED DESCRIPTION OF THE INVENTION

In the current state of broadband networks, including the Internet, the network is split into distinct domains which, at the boundaries where they intersect, do include the necessary security protocols to allow simple secure transactions between the domains. For example, a user in a home or small business network may desire to pay for the services or content provided by a third party service provider. In order to get that content, the content must travel from the provider's network over an access network, and possibly a public internet, to a carrier network, and to the user's network and device, again possibly using an access network and a public internet. For a single transaction, the user may be able to establish an account with a user name and password and may provide credit card information to access the content. Unfortunately, since only a user name and password is used these types of transactions are not as secure as could be achieved by using a physical security token by the user. Further these transactions are done on a single transaction basis, where the user must log into their account for every transaction.

What is missing from current broadband networking is a digital supply chain which links the user, carrier and provider. The digital supply chain would use an identity association to provide a secure explicit path through the individual networks (including the provider network, the carrier network, the public network and the user's network) and an authorized relationship and billing agreement between the user and the provider and/or carrier. An identity association, as used herein, refers to a unique token on the user's side of the network and an entry in a provider database corresponding to the token. In the concepts described herein, the token is preferably a physical token such as a smart card or other identifying device issued by a provider that can be used by a user to create an association between the user and the provider. The identity association then allows for derived services between the user and the provider. Such derived services can include allowing the user and provider to establish a security association between the provider's network and the user's device or network. A security association as is understood in the art is a connection between end points that uses security information shared between the end points to support secured communication. The identity association can also be used to allow other derived services, such as establish billing relationships and to enable other services between the user and provider or providing device access or content access in a trusted domain. Using the identity association the digital supply chain can be established allowing carriers and providers to provide such secure content and services to an end user to establish billing arrangements with the user that do not require separate authentication and credit card entry for each transaction. Advantages of local storage of secure content are an enhanced consumer experience since the content is immediately available to the user, as well as reduced costs for the carrier and provider in the form of reduced facility costs, reduced transport costs and reduced consumption of network resources.

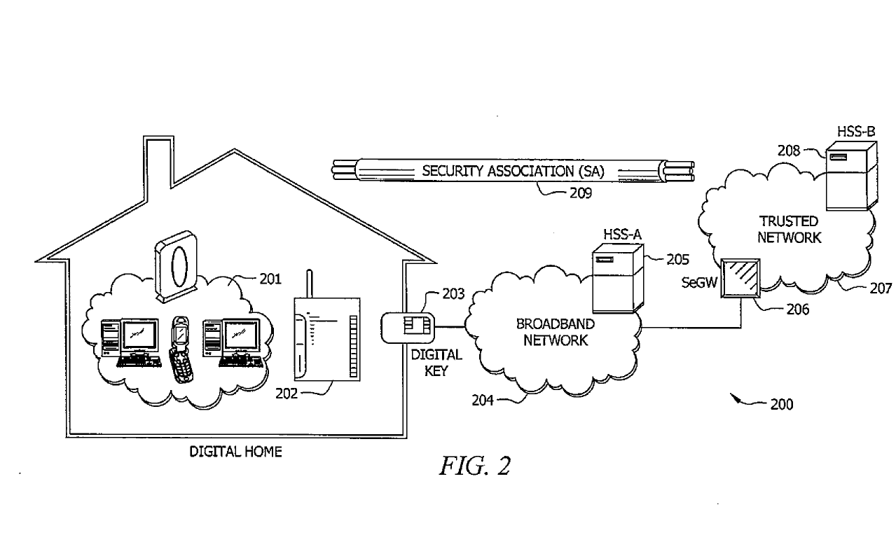

Referring now to FIG. 2, an embodiment of a system 200 for providing secure, trusted access between devices in a private network 201, such as a home network, and a trusted network 207, is shown. Home network 201 uses a private addressing scheme with NAT functionality provided by device 202. Home network may consist of wired network connections, such as Ethernet or cable, wireless networks such as under the IEEE 802.11 scheme, or cellular networks as provided by a cellular femtocell. Other types of networking protocols that use one or more of the previous media are also included in the types of protocols which can be utilized by the concepts described herein. Examples of these other protocols include MoCA (Multimedia over Coax Alliance), HomePNA (Home Phoneline Networking Alliance), VDSL (Very High Speed DSL), or PLC (Power Line Communication).

Device 202 provides the connection between broadband network 204 and home network 201. As described, device 202 provides the NAT functionality to interface between the private network addressing scheme of home network 201 and the public addressing scheme of broadband network 204. Device 202 can also include router and wireless and cellular access point functionality or may be connected to generic base station to provide the access point functionality. According to the concepts described herein, device 202 is also responsible for providing secure access to the home network and authenticating the end user devices in home network 201 as trusted devices.

To accomplish this, device 202 uses digital keys 203 which are incorporated into or are interfaceable with device 202. Digital keys 203 include digital security credentials and may or may not be used in conjunction with user ids and passwords for authentication. The digital keys are incorporated into a digital key interface, which can be a physically connected device which is inserted into a port on device 202, or can be connectionless such as embodiments where the digital key interface is part of an RFID or Smart Card device which is then placed in the proximity of a reader such as device 202. Digital keys 203, by establishing an identity association, may also be used in certain embodiments to implement a secure association according to the appropriate standards, such as GAA (Generic Authentication Architecture) 3GPP (Third Generation Partnership Project), or other similar standard. Device 202 and digital keys 203 allow for the encryption of communications to and from device 202 using IPSec or any other appropriate encryption scheme.

Digital keys 203 are, therefore, able to provide an identity association which then allows a secure explicit path, shown by security association (SA) 209, to be created. The digital keys 203 are therefore able to provide the functionality provided by the SIM card in the cellular network context. The digital keys 203 with the device 202 are able to provide a billable identity for the home, or business, or individual user in the home or business that could be used by a device in private network 201 for both communications and content delivery

As described, device 202 provides the interface between private network 201 and broadband network 204. Broadband network 204 includes authentication server 205 which is operable to manage the identity association through broadband network 204. Authentication server 204 can be a home subscriber server which maintains a home location registration that keeps trace of services for each subscriber similarly to the subscriber registry in a cellular network. Broadband network 204 is connected to trusted or provider network 207 through security gateway 206. Security gateway 206 provides secure termination and aggregation for user endpoints that are accessing the trusted core network. The security gateway provides IPSec Encryption, dynamic session security and real-time bandwidth management to provide security for multiple trusted connections with end user devices such as device 202. Security gateway 206 can be security gateway or session controller as is commonly available. Security gateway 206 provides the termination of security association 209 in the core of trusted network 207. While authentication server 205 provides subscriber services for the broadband network, authentication server 208 provides similar functionality for the provider network 207. Such functionality could alternatively be provided externally by a third party, such as, for example, an application service provider (ASP). Authentication server 208 includes a registry database that keeps track of subscriber identities and allowed services and service and subscriber parameters. The functionality provided by security gateway 206 and/or the authentication server 208 create an authentication mechanism that can be used in conjunction with device 202 and digital keys 203 to establish an identity association. While the authentication mechanism of FIG. 2 has been described with reference to both the security gateway and authentication server, the function of the authentication mechanism could be performed by either one of the devices individually. Further, the security gateway or authentication server could be implemented virtually on one or more devices while still operable functionally to provide the authentication mechanism described herein.

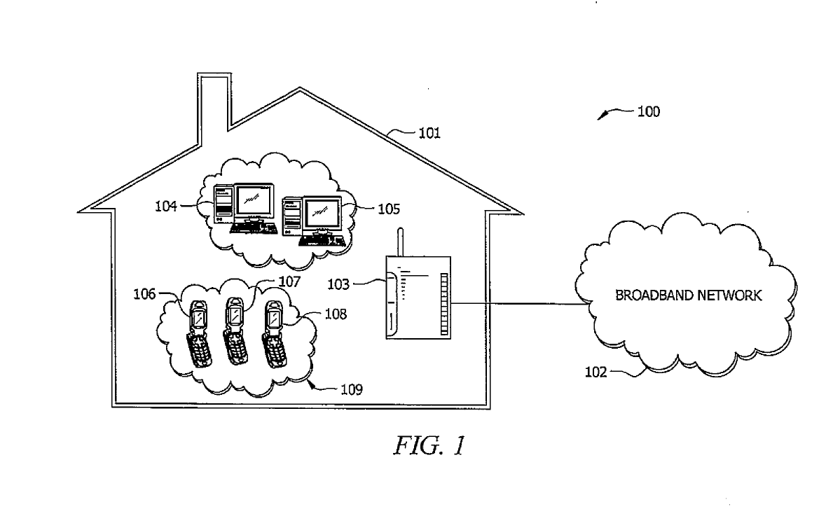

By providing a secure path 209 between private network 201 and trusted network 207, system 200 is able to provide functionality not realizable with the network shown in FIG. 1. System 200, using device 202, digital keys 203 and security gateway 206, is able to provide both secure identity and path between trusted network 207 and private network 201, effectively extending the reach of trusted network 207 to the end user devices in private network 201, and is also able to provide billing identities and relationships not available to traditional broadband network providers.

Different types of functionality are available based on the types of trusted networks connected using the identity association. For example, in embodiments of the system where the trusted network is a content provider, the content provider may be willing to enter into a relationship with a customer to provide content in exchange for the customer receiving advertising from the content provider. In such a case the content provider, based on its relationship with the customer, can enter into an agreement with the provider of the broadband network to provide enhanced services from the content provider to the customer. Based on the billable identity of the customer, the network provider would be able to charge the content provider for the enhanced services, which the content provider would pay for through advertising revenue based on advertising provided to the customer.

In lieu of providing free content to the customer, the content provider may provide pay-per-view or pay-per-use content. In such a case, the customer's billable identity would allow the broadband network provider to bill the customer for the ordered content. The network provider could then keep a percentage of the pay-per-use fees and remit the remaining fee to the content provider. The network provider would be able to leverage its billing relationship with the customer, freeing the content provider from having to bill each end customer.

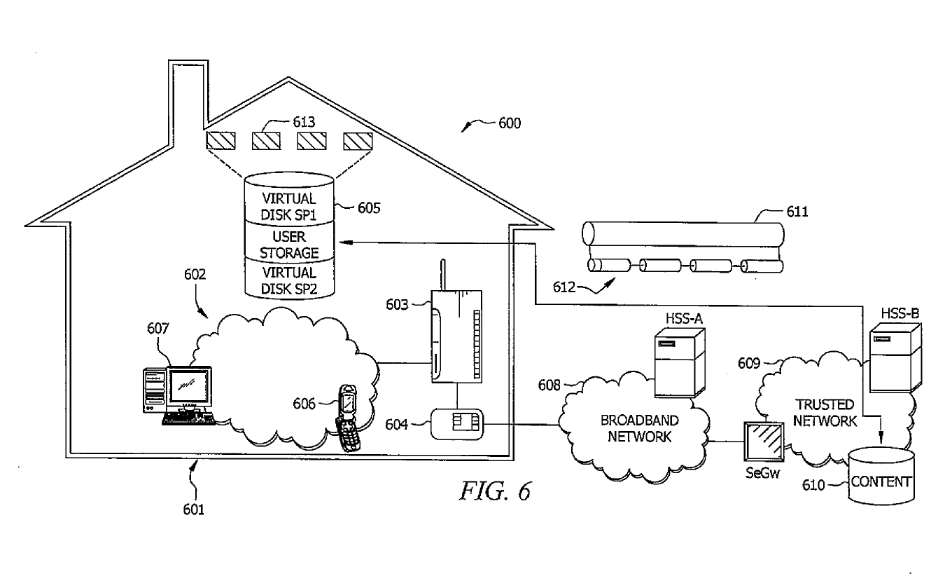

In another embodiment of the system, the identity association would be able to extend the reach of the trusted network to the end user devices. For example, if the trusted network was a wireless provider, the existence of the identity association would allow the mobile customers to access content and devices in the private network from their mobile devices over a secure connection, or could allow data from the private network to be pushed to the mobile device upon the occurrence of a triggering event in the private network. An example of pulling data from private network will be described with reference to FIG. 6. In the case of pushing data from the private network, an event such as the triggering of a security alarm could cause the home network to push data, such as an alert and security camera pictures to the user of a wireless device.

While particular examples have been described to illustrate the types of applications available using a system incorporating the concepts described herein, the examples are not limiting, and any type of functionality or application could be implemented that relies on the identity association, or resulting security association or billable identity or any of the other features described according to the concepts set forth herein.

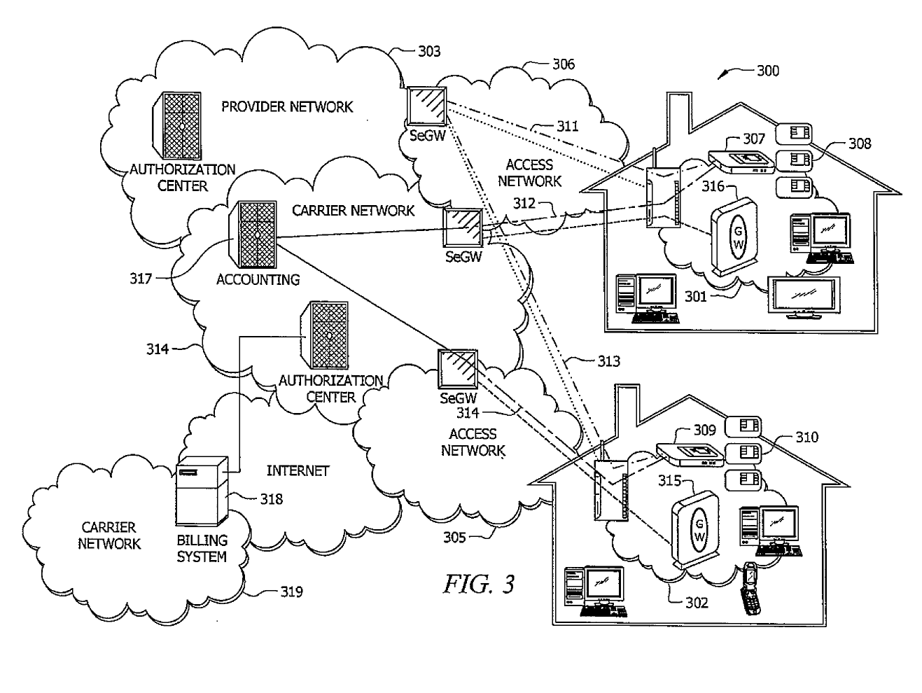

Referring now to FIG. 3, an alternate embodiment of a system 300 for providing secure, trusted access between devices in private networks 301, 302, such as a home network, and a provider network 303 or trusted carrier network 304 using an access carrier network 305 or the Internet 306, is shown. System 300 operates similarly to system 200 from FIG. 2 except that the different layers of network traffic (i.e. the signaling layer and the media layer) are each potentially controlled by separate devices. Where a single device, device 202 from FIG. 2, handles both the signaling and media channels, that functionality is distributed over multiple devices in system 300.

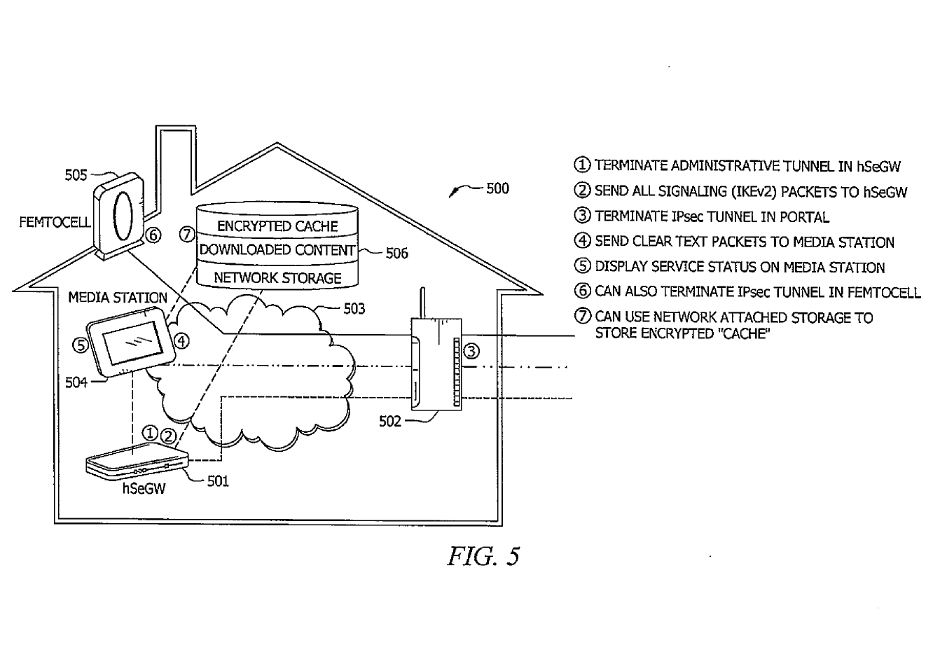

Specifically, the policy enforcement and signaling functionality is performed by home security gateway 307, 309. Home security gateway includes the ability to read digital keys 308, 310 used to provide the trusted relationship between the subscriber and the carrier, merchant, or provider of content or services. Using the digital keys, home/subscriber security gateway, 307, 309 is able to create the security associations 311, 312, 313 and 314 which allow for trusted communication between the subscriber and the carrier 303 or provider 304. Unlike system 200 from FIG. 2, however, the services or content can be sent directly to a separate device such as a computer, phone, cellular phone, television, home appliance, or other network enabled device, illustrated in FIG. 5 by devices 315 and 316. This separation allows one device to control all of the policy and signaling information for any number of network enabled devices in the home. In this manner there is a single point of reference for the digital keys and the physical keys do not need to be moved from device to device when used.

The digital keys are preferably physical devices including contactless devices (e.g. smart cards, or devices using RFID type technologies) or contacted devices (e.g. devices inserted into a port on the device). Using a physical device increases the security of a connection by requiring the physical device to be present to establish the connection and is much harder to duplicate or fake than a purely digital security certificate. A home security gateway may have any number of digital keys as required by the subscriber and devices to be used.

Another application of system 200 or system 300, particularly system 300 using home security gateway 307, 309, would be to create secure payment relationships usable by the subscriber. As described, the digital keys can be used to create a billable identity with the subscriber. As such, the home security gateway, as a single point of reference with the digital keys can be turned into a digital wallet to provide secure payment and billing relationships between the subscriber and a carrier, provider or vendor on the network. As the carrier and the subscriber have a trusted relationship with the carrier having a billable identity with the subscriber through the use of the digital keys, the carrier can also act as an intermediary in payment or billing relationships between the subscriber and providers, merchants or vendors. The carrier could use its billing relationship with the subscriber to bill for services, content or items purchased by the subscriber, with the vendors/providers getting a single billing point for many customers. In this manner, vendors/providers can avoid having to establish billing relationships with many individual subscribers. Such billing relationships are illustrated in system 300 by the accounting server 317 in carrier network 304 and billing system 318 in network 319.

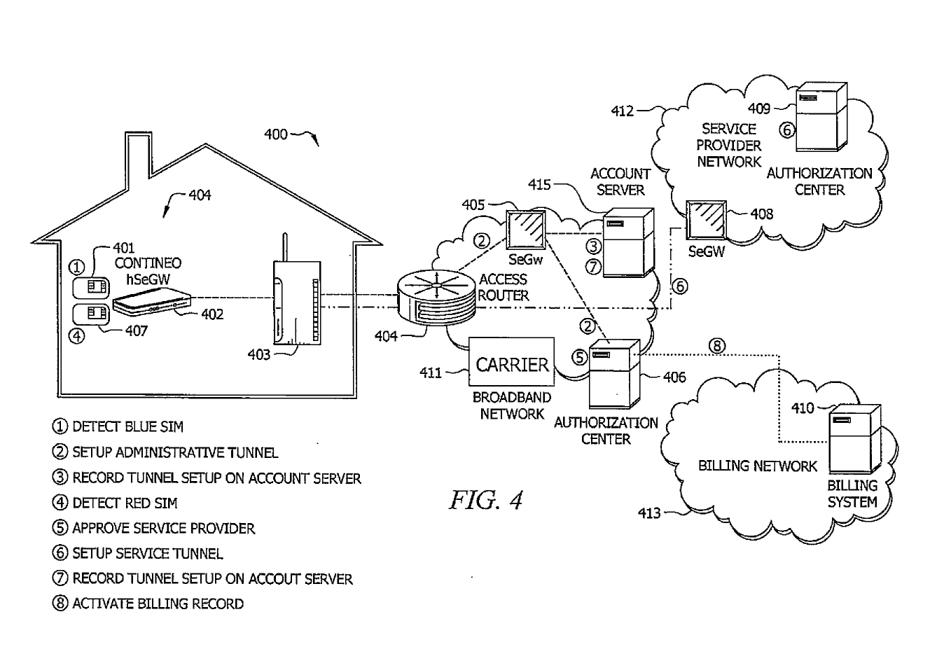

Referring now to FIG. 4, an embodiment of a system 400 for creating and utilizing secure identity associations is shown. System 400 includes device 402, which accepts digital keys 401 and 407. A portal 403, such as a DSL or cable modem, or other interface device with a public network 411, is used to connect device 402 to carrier access network 411. Service provider network 412 and billing network 413 are also connected with carrier access network 411, though the connection between any of the networks shown may utilize a public network 411.

An embodiment of a process for creating an identity association between the service provider in service provider network 412, and a user in private network 404 using the concepts described herein begins with the detection of digital key 401. Digital key 401 may be provided to the end user by the carrier who provides the end user with access to the carrier access network, or by any other interested entity, such as the content provider or a entity who provides key management for any of the parties. In this case the carrier access network 411 is the carrier's network and provides the end user with access to the Internet and other networks connected to the carrier's private network. Once digital key 401 has been detected by device 402, device 402 proceeds to make the identity association, or set up an administrative tunnel with the carrier using the device 402 and security gateway 405. Authentication server 406 in the carrier's network authenticates the user's identity and privileges using the information on digital key 401, and then records the tunnel setup on account server 415.

Once the identity association and corresponding security association between the carrier and the end user has been established, the end user can then use that security association to establish other identity associations with service providers. Digital key 407 is a digital key issued by the service provider associated with service provider network 412. As described, service provider may be a provider of services, content, goods, etc. Device 402 detects service provider digital key 407, and then sends information associated with that key to the carrier's network to establish the identity association with the service provider using authentication server 406. A security association, or service tunnel, is then set up using security gateway 408 between the device 402 and the service provider network 412. That service tunnel is also recorded on account server 415. Once the service tunnel has been established, a billing record can be activated on billing server 410 in billing network 413 to allow billing of the transaction between the end user and the service provider. The billing system can be part of the carrier or can be part of a third party billing system.

While the process shown in FIG. 4 first requires the setting up of an identity association with the carrier before the identity association is established with the service provider, the system could be set up to allow the end user to establish an identity association directly with the service provider without requiring that the identity association with a carrier having been previously established. Thus, while the digital supply chain may be between the user, carrier and provider, a digital supply chain just between the user and provider is well within the scope of the concepts described herein.

Referring now to FIG. 5 an embodiment of a home network which is able to store pre-placed content from a provider is described. Using the security association, embodiments of system 500 can include storage attached to the private network, as shown by storage device 506. The storage may be any type of storage device, such as network attached storage, internal or external storage associated with a computer or digital video recorder, or any other storage in system 500. Using the security association and billing identities that the identity association allows, providers can pre-place encrypted content onto storage device 506 such that it is immediately available to a user or other device on private network 503. The user, using the billing identity established as a result of the identity association could then agree to pay a fee, or watch advertising, or any other precondition placed by the provider, at which point the provider would send the appropriate keys over the secure connection to decrypt the content for the user. The concepts described herein allow for the pushing of encrypted content into the private network because of its security associations, and can eliminate the need to have such content cached in devices in the network itself, thereby freeing network resources and improving service performance.

The embodiment of system 500 shown in FIG. 5 allows for separating the media streams and control streams which can be particularly useful in pre-placing of secure content. In system 500 device 501, media station 504 and femtocell 505 are connected to a private network 503 which connects to a public network through portal 502. An administrative tunnel between the private network and the carrier for all the equipment connected to private network 503 is terminated at device 501. Device 501 controls all of the policy enforcement for all of the equipment on private network 503. Once the administrative tunnel is established, signaling packets entering private network 503 can be sent to device 501 as appropriate.

While all signaling packets are sent to device 501, device 501 can instruct portal 502 to direct media packets to another device on private network 503, such as media station 504 or femtocell 505. The separation of signaling or administrative packets from the media or content packets allow device 501 to operate as the policy enforcement point for private network 503. It also allows device 501 to serve as a central point for digital keys which can then be used for services on other equipment connected to private network 503. Thus the policy enforcement, identity and billing functionality can be focused at a single device as opposed to requiring each piece of equipment in the network to have such capability.

Referring now to FIG. 6, an embodiment of digital supply chain using identity associations to allow trusted access into an end user's network is described in greater detail. System 600 operates essentially as is described with reference to system 200 in FIG. 2. Device 603 is able to receive a digital key 604 provided by trusted network 609. Using that digital key 604, device 603 is able to create an identity association between device 603 and home network 602 in home 601 and trusted network 609 in the same manner as has been described above. Once the identity association has been established a security association 611 can be established to secure communications between home network 602 and trusted network 609. The identity association and resulting security association, once established can be used to allow the trusted network to pre-place content 610 onto a storage device 605 in the home network. The storage device 605 can be a single storage device accessible over the home network, such as a network attached storage device, or could be comprised of multiple storage elements resident on other devices in network 602, such as the hard drives of computer 607 or television 606 or a set top box or digital video recorder associated with televisions 606.

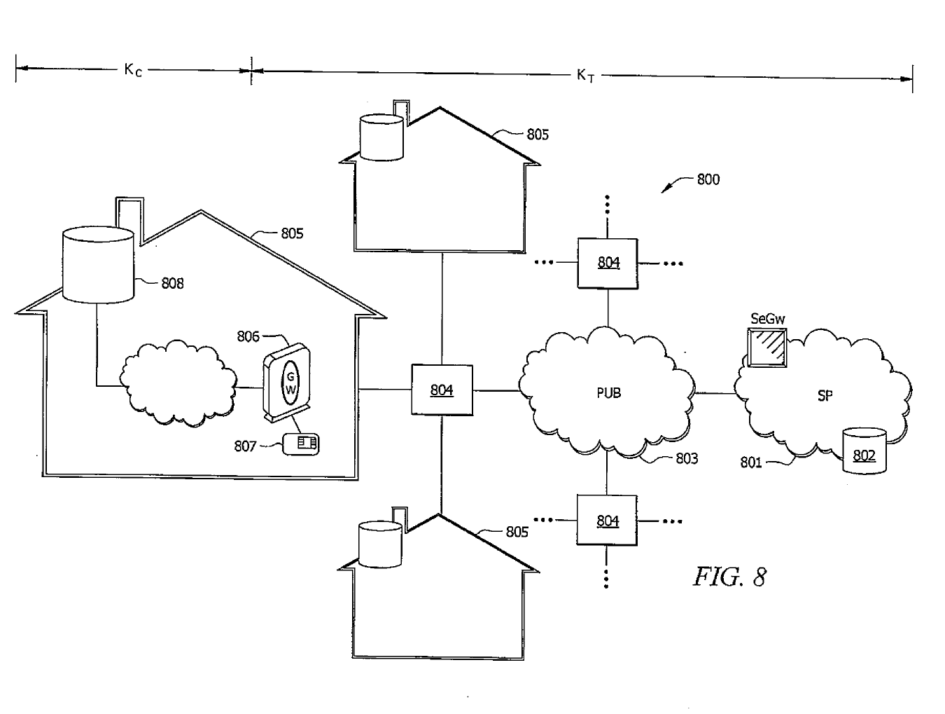

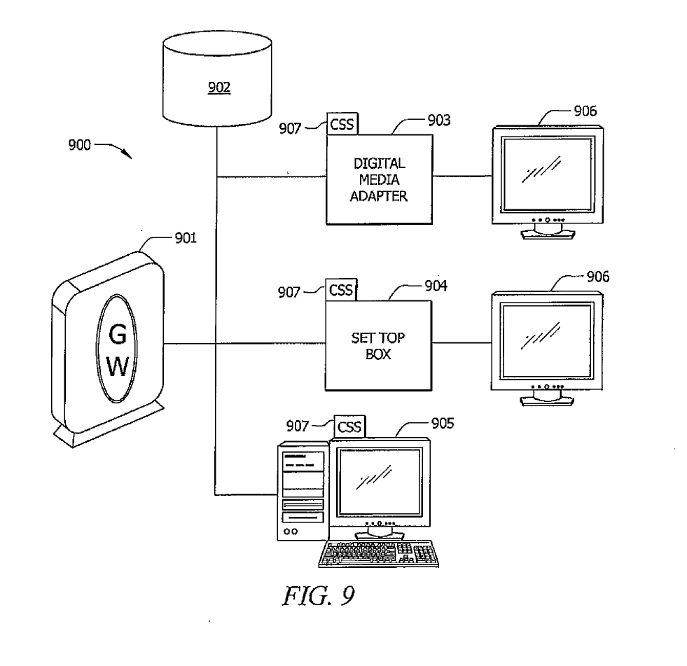

Using security association 611, provider is able to send content 610 to storage device 605 using a secure data transfer protocol, shown by encrypted packets 612. Embodiments of the concepts described herein use a single encryption scheme, and therefore a single key, for both transport to get the content to the local storage device and for access control once the content is on the local storage device. Other preferred embodiments use an encryption scheme having a transport key KT for the transport of the content, and a separate encryption scheme having a content key Kc for access control. This allows for transport to take place using shared transport keys while each user will have a unique access control key. Examples of such a scheme will be discussed in greater detail with reference to FIGS. 8 and 9.

In the two key system, once the content arrives at the end user network, the encryption used during the transfer is no longer present to protect the content until the user has agreed to the terms required to access the content. The content, therefore, needs to be encrypted while it is resident on the end user device. There are many encryption schemes that can be used to protect the provider content, including CFS (Cryptographic File System, GEOM encryption, vnd encryption, and the like. One scheme that may be particularly suitable for embodiments of the concepts described herein is the CrpytoGraphic Disk or CGD. CGD, or other encryption schemes used with the present invention, may allow the content to be stored and encrypted in predefined blocks as shown by encrypted blocks 613. The encryption of the content at the end user storage can be done at the file level and can be modified by the content provider. Each new access by the user could require re-authorization, or the retrieval of a new content key Kc

In embodiments of the concepts described herein, providers may be given access to defined parts of the user storage device such as is shown by virtual disk SP1 and virtual disk SP2, while these may be on the same storage device as user storage data, those virtual disks could be encrypted as described herein and available for use by the provider. While particular reference has been made to specific protocols and encryption schemes, such as iSCSI and CGD, any secure data storage protocol or technique and any encryption scheme or technique may be used that accomplishes the requirements set forth herein.

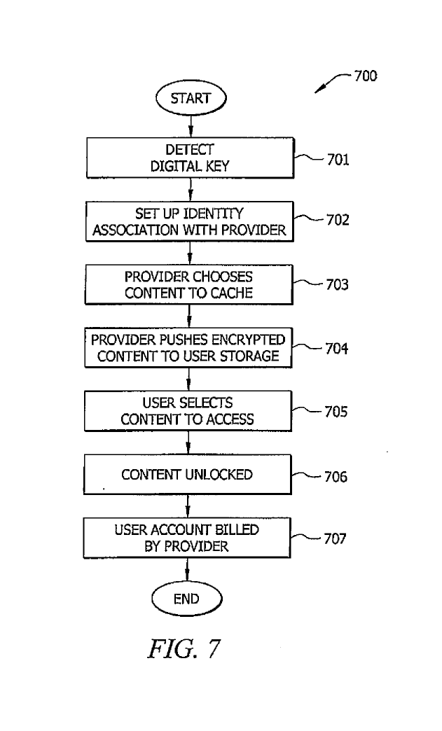

Referring now to FIG. 7, a method for pre-placing secure content on an end user's network is described. Method 700 begins with process 701 which detects a digital key at a device in the end user network. Digital key 702, in process 702, is then used to set up an identity association with the trusted provider associated with the digital key, as has been well described. Process 703 then selects content to be cached on the end user network. The content may be chosen based on the previous history of the end user, on information relating to the end user, such as demographic data, on a list of desired content provided by the end user, or on any other basis or criteria used by the provider. The content is then sent by the provider to storage on the end user network using a secure data transfer protocol as described with reference to FIG. 6 and shown by process 704. The content is encrypted using a key provided by the content provider

Once the content has been pre-placed on the user network, the user will be able to see through an interface to the home network that the content is available. Process 705 shows the end user selecting the content. When the content is selected by the user, the content is “unlocked”, as shown by process 706, and the user is provided access to the content according to the terms established between the provider and end user. The content may be unlocked by a key sent by the provider in response to the selection by the end user, or the mechanism for unlocking the content may be controlled by the device on the end user network or may be stored with the content itself and then reported back to the provider at the time the content is unlocked. Once the content is unlocked for the end user, the end user's account may be billed by the provider, as shown by process 707. Though method 700 has been described for one provider and a single piece of content, any number of providers can cache content for an end user and any amount of content can be cached, based on the end user's system, while still being within the scope of the concepts described herein.

Referring now to FIG. 8, an embodiment of a system for distributing content according to the concepts described herein using multicast network technology is shown. System 800 operates much as described above. Service provider 801 uses an identity association enabled by device 806 and digital key 807 to pre-place content 802 onto target drive 808 in an end user network 805 using public network 803. To increase the efficiency of such pre-placement, the service provider may take advantage of multicasting to allow for large scale distribution of content to multiple end user devices 809, simultaneously using multicast routers 804.

IP Multicast is a technique for one to many communication over an IP infrastructure. It scales to a larger receiver population by not requiring prior knowledge of who or how many receivers there are. Multicast utilizes network infrastructure efficiently by requiring the source to send a packet only once, even if it needs to be delivered to a large number of receivers. The nodes in the network take care of replicating the packet to reach multiple receivers only where necessary. Key concepts in IP Multicast include an IP Multicast group address, a multicast distribution tree and receiver driven tree creation. One protocol used IP Multicasting is called the Internet Group Management Protocol or IGMP. Once the receivers join a particular IP Multicast group, a multicast distribution tree is constructed for that group. IP Multicast does not require a source sending to a given group to know about the receivers of the group. The multicast tree construction is initiated by network nodes which are close to the receivers or is receiver driven. This allows it to scale to a large receiver population.

In one embodiment using IP Multicasting for pre-placement of distributed content the keys for the transmission and content access must be separated as the same transmission mechanism is being used for multiple users. In this case key Kt is used for the transmission function and secures the content as it is being transmitted. After the content is pre-placed on the target device 808, key Kc is used to access the content. Key Kc is controlled by the content/service provider, who can use device 806 and its associated digital key to provide access control to the content. Preferably, when the user wishes to access the secure content, device 806 contacts the content provider and requests the key information to unlock Key Kc Device 806 can manage the distribution of the key in the end user network 805 and coordinates the key management with the service provider.

Referring now to FIG. 9, a an embodiment of a system for distributing keys within an end user network according to the concepts described herein is shown. End user network 900 includes device 901 which interfaces with digital keys as described herein and manages identity associations. Device 901 can also be used to manage key distribution for pre-placed content. Once the secure content has been placed on a device in the network such as storage device 902, digital media adapter 903, set top box 904, computer 905 or other similar device connected to network 900, those devices need to be able to get and use the key required to unlock the content. Device 901 can use applets 907 which are run on, or have access to the various devices. Applets 907 can control the file operations and request the key from device 901.

Device 901, in addition to controlling key access, can also control other attributes of the process using the appropriate keys. Content pre-placed on the end user network can have other restrictions placed on it by the service provider. For example, the content could be a broadcast show with a set air time. One restriction controlled by device 901 is to not allow access to the content until at or after its appointed air time. Further restrictions could be a limited access period after the content is unlocked or could be restrictions on the types of devices that the content may be used on, or any other restrictions that could be used by the service provider to control the content and its use.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for pre-placing content from a provider on an end user storage device, the system comprising:
a device connected to an end user network and a public network and used to interface with one or more digital keys, each digital key able to control one or more identity associations; and
a storage device attached to the end user network, the storage device operable to receive content from the provider using the identity association with the provider;
wherein the content is encrypted on the storage device using a keys established by the provider, such that the end user can only decrypt and access the content by agreeing to terms established by the provider using the digital key and identity association with the provider.

2. The system of claim 1 wherein the trusted network is controlled by a service provider providing services to the private network.

3. The system of claim 2 wherein service provider is one of a content provider, a service provider, a merchant, a network operator.

4. The system of claim 1 wherein the device is used to terminate a control channel between the private network and the trusted network while an associated bearer channel is terminated at an end user device.

5. The system of claim 1 where the identity association is used to provide a billable identity for the end user device.

6. The system of claim 2 further comprising storage in the private network, wherein the service provider can pre-place content into the storage for use by end users.

7. A method for pre-placing content from a provider on an end user storage device, the method comprising:
establishing an identity association between a provider and an end user storage device using a device connected to the end user network and used to interface with one or more digital keys, each digital key able to control one or more identity associations;
sending content from the provider to the end user storage device over a secure connection using the identity association;
encrypting the content on the end user storage device using keys provided by the provider; and
decrypting the content in response to a request by the end user, the end user agreeing to terms established by the provider using the digital key and identity association with the provider.

8. The system of claim 7 wherein the provider is a network carrier.

9. The system of claim 7 wherein the provider is a content provider.

10. The system of claim 7 wherein the provider is a provider of services.

11. The system of claim 7 wherein the provider is a merchant.

12. The system of claim 7 further comprising a security gateway in the trusted network, the security gateway including a registry for authenticating an end user subscriber using the digital key and for maintaining a record of the end user subscriber's relationship with a provider.

13. The system of claim 12 wherein the provider is able to use the digital key to establish a billing identity with the end user subscriber.

14. A system for pre-placing content from a provider on an end user storage device, the system comprising:
a device connected to an end user network and a public network and used to interface with one or more digital keys, each digital key able to control one or more identity associations;
a storage device attached to the end user network;
a trusted network connected to the public network and capable placing content on the storage device in the end user network using the identity association with the provider
wherein the content is encrypted on the storage device using a keys established by the provider, such that the end user can only decrypt and access the content by agreeing to terms established by the provider using the digital key and identity association with the provider.

15. The system of claim 14 wherein the provider is able to push content to the storage device using the identity association without further authorization from the end user.

16. The system of claim 14 wherein the trusted network is controlled by a service provider providing services to the private network.

17. The system of claim 15 wherein service provider is one of a content provider, a service provider, a merchant, a network operator.

18. The system of claim 14 wherein the device is used to terminate a control channel between the private network and the trusted network while an associated bearer channel is terminated at an end user device.

19. The system of claim 14 where the identity association is used to provide a billable identity for the end user device.

20. The system of claim 15 further comprising storage in the private network, wherein the service provider can pre-place content into the storage for use by end users.
